(19) United States
(12) Patent Application Publication
(10) Pub. No.: US 2015/0242948 A1
(43) Pub. Date: Aug. 27, 2015

(54) METHOD AND SYSTEM FOR VALIDATING MULTIPLE DOCUMENTS ASSOCIATED WITH A TRANSACTION

(71) Applicant: THE TORONTO-DOMINION BANK, Toronto (CA)

(72) Inventors: ARTUR MACZUSZENKO, MILTON (CA); APARNA JAIN, RICHMOND HILL (CA); LISA JANE BELL, NEWMARKET (CA)

(21) Appl. No.: 14/698,680

(22) Filed: Apr. 28, 2015

Related U.S. Application Data
(63) Continuation-in-part of application No. 14/515,044, filed on Oct. 15, 2014.
(60) Provisional application No. 61/985,083, filed on Apr. 28, 2014.
(60) Provisional application No. 61/891,059, filed on Oct. 15, 2013.
(60) Provisional application No. 61/985,083, filed on Apr. 28, 2014.

(51) Int. Cl. G06Q 40/02; G06Q 10/10

(52) U.S. Cl. CPC G06Q 40/025; G06Q 10/10

(57) ABSTRACT

A method for validating multiple documents associated with a transaction, comprising: using a processor, determining whether respective values from the multiple documents are valid; when the values are valid, aggregating the values to determine an aggregate value; and, determining whether the aggregate value is valid, validity of the values and the aggregate value being indicative of validity of the multiple documents.

This application is a continuation-in-part of U.S. patent application Ser. No. 14/515,044, filed Oct. 15, 2014, and incorporated herein by reference, and claims priority from and the benefit of the filing date of U.S. Provisional Patent Application No. 61/891,059, filed Oct. 15, 2013, and incorporated herein by reference, and U.S. Provisional Patent Application No. 61/985,083, filed Apr. 28, 2014, and incorporated herein by reference.

### FIELD OF THE INVENTION

This invention relates to the field of data processing, and more specifically, to a method and system for validating multiple documents associated with a transaction.

### BACKGROUND OF THE INVENTION

Rule-based technologies, ranging from stand alone inference engines and expert systems to development tools, have been developed that allow programmers to program business rules and processes into system environments. These efforts include the development of workflow and routing applications, customer relationship management (“CRM”), and enterprise resource planning (“ERP”) systems for automating portions of business transactions. Moreover, many companies have developed proprietary applications based on hard-coded rules and process configurations. Despite these automation efforts, many front and back office operations to process business transactions in the services industry still rely greatly on human operators working with legacy systems. These manual work processes may be found in the banking industry (e.g., mortgage application and issuance, etc.), the insurance industry (e.g., policy underwriting and issuance, customer service, etc.), and the like.

For example, consider the mortgage application process as a form of transaction or business transaction. The purchase of a home is typically the largest investment that a person makes. Because of the amount of money required to purchase a home, most home buyers do not have sufficient assets to purchase a home outright on a cash basis. In addition, buyers who have already purchased a home may wish to refinance their home. Therefore, potential home buyers consult lenders such as banks, credit unions, mortgage companies, savings and loan institutions, government housing finance agencies, and so on, to obtain the funds necessary to purchase or refinance their homes. These lenders offer mortgage products to potential home buyers or borrowers. Borrowers may also obtain information regarding available mortgage products from other types of advisors such as mortgage brokers and realtors.

Typically, when a borrower works with an advisor to obtain a mortgage, the advisor first obtains various financial and other information from the borrower. Using this information, the advisor selects a particular mortgage product for the borrower which the advisor perceives as likely being available to the borrower. The borrower may be required to submit a number of documents such as pay stubs to verify income, declarations that certain court judgments do not refer to them or encumber their property, and so on. In many instances, the information is not required initially, but is required upon further processing of the application. Managing the flow of information and the associated documents that include the information is often a formidable task, especially in situations where a large number of applications are being processed simultaneously. For example, due to the high volume of applications, the need to obtain certain information from an applicant may be delayed or forgotten causing delay in the approval of the mortgage application. Such delays and associated costs may increase the overall cost of borrowing money to pay for the home.

In general, mortgage applications are reviewed on a variety of different levels by the lender's mortgage officers to determine the level of risk involved in lending a requested amount of money to the applicant. Once approved, a mortgage application may then undergo a fulfillment process that may require significant amounts of time. Applicants, however, generally want to obtain a mortgage quickly and painlessly. As such, applicants will often choose a lender based on the speed with which their applications will be processed and, if approved, the speed with which their loans will be fulfilled. Current methods and systems for mortgage application approval and fulfillment involve highly manual and segmented processes. For example, mortgage applications may be reviewed and analyzed by personnel in multiple departments within the lender's organization before a decision is made regarding approval. A similarly segmented process may be used for fulfilling a mortgage application. Each department may require a day or more to review the loan application, obtain any necessary supplemental information, and formulate a decision. This may result in significant delays in processing the mortgage application which may cause the applicant frustration and dissatisfaction.

As such, to approve mortgage applications quickly, mortgage officers typically require skill at navigating multiple, divergent legacy claims and policy administration systems. They must learn and apply complex business rules and processes outside of these systems which are frequently changing, handle infinite combinations and permutations of incident types and know their employer's many product and benefit entitlements intimately. In addition, while managing these complex knowledge matrices, they must also remain tuned in to the needs of the applicant who wants clear affirmation and confidence in the approval of their application. At each step in the manual processing of the mortgage application there is an opportunity for human error. Each error exposes the lender to substantial losses, and the unnecessary additional administration costs that result from the rework required to resolve the error, not to mention the frustration and dissatisfaction of the applicant.

A need therefore exists for an improved method and system for validating multiple documents associated with a transaction. Accordingly, a solution that addresses, at least in part, the above and other shortcomings is desired.

### SUMMARY OF THE INVENTION

According to one aspect of the invention, there is provided a method for validating multiple documents associated with a transaction, comprising: using a processor, determining whether respective values from the multiple documents are valid; when the values are valid, aggregating the values to determine an aggregate value; and, determining whether the aggregate value is valid, validity of the values and the aggregate value being indicative of validity of the multiple documents.

In accordance with further aspects of the invention, there is provided an apparatus such as a data processing system, a method for adapting same, as well as articles of manufacture such as a computer readable medium or product and computer program product or software product (e.g., comprising a non-transitory medium) having program instructions recorded thereon for practising the method of the invention.

### BRIEF DESCRIPTION OF THE DRAWINGS

Further features and advantages of the embodiments of the present invention will become apparent from the following detailed description, taken in combination with the appended drawings, in which:

FIG. 1 is a block diagram illustrating a data processing system in accordance with an embodiment of the invention;

FIG. 2 is a chart illustrating a structure for aggregating mortgage application related information in accordance with an embodiment of the invention;

FIG. 3 is a flow chart illustrating the application of business rules for aggregating mortgage application related information according to the structure of FIG. 2 in accordance with an embodiment of the invention;

FIG. 4 is a screen capture illustrating a document level screen for a mortgage application related document in accordance with an embodiment of the invention;

FIG. 5 is a screen capture illustrating a pop-up window for the mortgage application related document within the document level screen of FIG. 4 in accordance with an embodiment of the invention;

FIG. 6 is a screen capture illustrating a properties and document image screen for the mortgage application related document of FIG. 4 in accordance with an embodiment of the invention;

FIG. 7 is a screen capture illustrating a like document level screen for like mortgage application related documents in accordance with an embodiment of the invention;

FIG. 8 is a screen capture illustrating a group document level screen for a customer in accordance with an embodiment of the invention;

FIG. 9 is a screen capture illustrating a deal level screen for one or more customers in accordance with an embodiment of the invention;

FIG. 10 is a screen capture illustrating a deal comparison screen in accordance with an embodiment of the invention; and,

FIG. 11 is a flow chart illustrating operations of modules within a data processing system for validating multiple documents associated with a transaction, in accordance with an embodiment of the invention.

It will be noted that throughout the appended drawings, like features are identified by like reference numerals.

### DETAILED DESCRIPTION OF THE EXEMPLARY EMBODIMENTS

In the following description, details are set forth to provide an understanding of the invention. In some instances, certain software, circuits, structures and methods have not been described or shown in detail in order not to obscure the invention. The temi “data processing system” is used herein to refer to any machine for processing data, including the computer systems, wireless devices, and network arrangements described herein. The present invention may be implemented in any computer programming language provided that the operating system of the data processing system provides the facilities that may support the requirements of the present invention. Any limitations presented would be a result of a particular type of operating system or computer programming language and would not be a limitation of the present invention. The present invention may also be implemented in hardware or in a combination of hardware and software.

The present invention is applicable to transactions and applications including business transactions, financial transactions, mortgage transactions, loan transactions, and applications for mortgages, loans, financial products, letters of credit, credit cards, passports, drivers' licenses, etc. In the following, an example embodiment for mortgage applications is used to illustrate the invention.

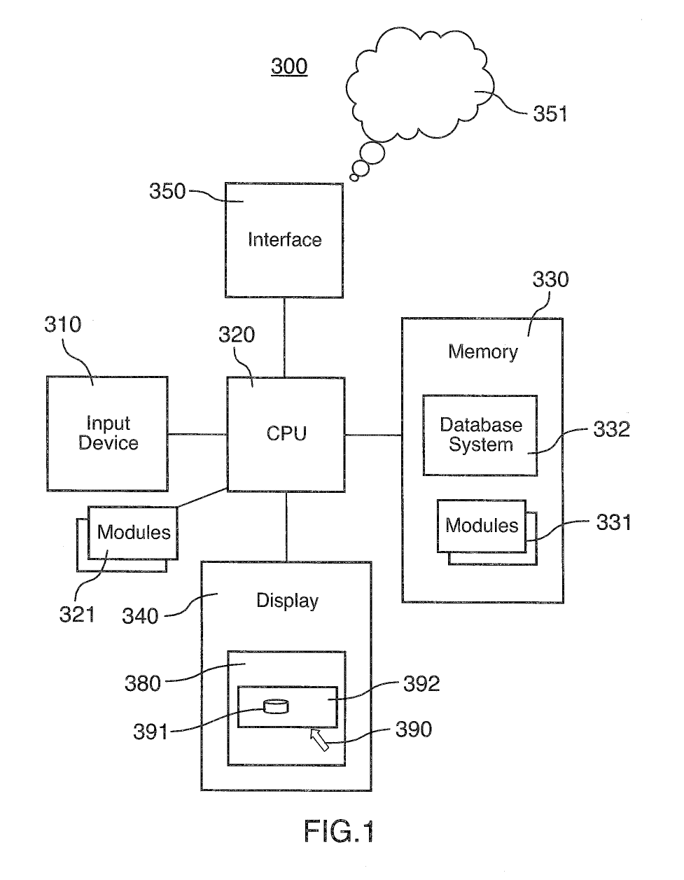

FIG. 1 is a block diagram illustrating a data processing system 300 in accordance with an embodiment of the invention. The data processing system 300 is suitable for data processing, management, storage, and for generating, displaying, and adjusting presentations in conjunction with a user interface or a graphical user interface (“GUI”), as described below. The data processing system 300 may be a client and/or server in a client/server system (e.g., 100). For example, the data processing system 300 may be a server system or a personal computer (“PC”) system. The data processing system 300 may also be a mobile device or other wireless, portable, or handheld device. The data processing system 300 may also be a distributed system which is deployed across multiple processors. The data processing system 300 may also be a virtual machine. The data processing system 300 includes an input device 310, at least one central processing unit (“CPU”) 320, memory 330, a display 340, and an interface device 350. The input device 310 may include a keyboard, a mouse, a trackball, a touch sensitive surface or screen, a position tracking device, an eye tracking device, or a similar device. The display 340 may include a computer screen, television screen, display screen, terminal device, a touch sensitive display surface or screen, or a hardcopy producing output device such as a printer or plotter. The memory 330 may include a variety of storage devices including internal memory and external mass storage typically arranged in a hierarchy of storage as understood by those skilled in the art. For example, the memory 330 may include databases, random access memory (“RAM”), read-only memory (“ROM”), flash memory, and/or disk devices. The interface device 350 may include one or more network connections. The data processing system 300 may be adapted for communicating with other data processing systems (e.g., similar to data processing system 300) over a network 351 via the interface device 350. For example, the interface device 350 may include an interface to a network 351 such as the Internet and/or another wired or wireless network (e.g., a wireless local area network (“WLAN”), a cellular telephone network, etc.). As such, the interface 350 may include suitable transmitters, receivers, antennae, etc. In addition, the data processing system 300 may include a Global Positioning System (“GPS”) receiver. Thus, the data processing system 300 may be linked to other data processing systems by the network 351. The CPU 320 may include or be operatively coupled to dedicated coprocessors, memory devices, or other hardware modules 321. The CPU 320 is operatively coupled to the memory 330 which stores an operating system (e.g., 331) for general management of the system 300. The CPU 320 is operatively coupled to the input device 310 for receiving user commands or queries and for displaying the results of these commands or queries to the user on the display 340. Commands and queries may also be received via the interface device 350 and results may be transmitted via the interface device 350. The data processing system 300 may include a data store or database system 332 for storing data and programming information. The database system 332 may include a database management system (e.g., 332) and a database (e.g., 332) and may be stored in the memory 330 of the data processing system 300. In general, the data processing system 300 has stored therein data representing sequences of instructions which when executed cause the method described herein to be performed. Of course, the data processing system 300 may contain additional software and hardware a description of which is not necessary for understanding the invention.

Thus, the data processing system 300 includes computer executable programmed instructions for directing the system 300 to implement the embodiments of the present invention. The programmed instructions may be embodied in one or more hardware modules 321 or software modules 331 resident in the memory 330 of the data processing system 300 or elsewhere (e.g., 320). Alternatively, the programmed instructions may be embodied on a computer readable medium or product (e.g., one or more digital video disks (“DVDs”), compact disks (“CDs”), memory sticks, etc.) which may be used for transporting the programmed instructions to the memory 330 of the data processing system 300. Alternatively, the programmed instructions may be embedded in a computer-readable signal or signal-bearing medium or product that is uploaded to a network 351 by a vendor or supplier of the programmed instructions, and this signal or signal-bearing medium or product may be downloaded through an interface (e.g., 350) to the data processing system 300 from the network 351 by end users or potential buyers.

A user may interact with the data processing system 300 and its hardware and software modules 321, 331 using a user interface such as a graphical user interface (“GUI”) 380 (and related modules 321, 331). The GUI 380 may be used for monitoring, managing, and accessing the data processing system 300. GUIs are supported by common operating systems and provide a display format which enables a user to choose commands, execute application programs, manage computer files, and perform other functions by selecting pictorial representations known as icons, or items from a menu through use of an input device 310 such as a mouse. In general, a GUI is used to convey information to and receive commands from users and generally includes a variety of GUI objects or controls, including icons, toolbars, drop-down menus, text, dialog boxes, buttons, and the like. A user typically interacts with a GUI 380 presented on a display 340 by using an input device (e.g., a mouse) 310 to position a pointer or cursor 390 over an object (e.g., an icon) 391 and by selecting or “clicking” on the object 391. Typically, a GUI based system presents application, system status, and other information to the user in one or more “windows” appearing on the display 340. A window 392 is a more or less rectangular area within the display 340 in which a user may view an application or a document. Such a window 392 may be open, closed, displayed full screen, reduced to an icon, increased or reduced in size, or moved to different areas of the display 340. Multiple windows may be displayed simultaneously, such as: windows included within other windows, windows overlapping other windows, or windows tiled within the display area.

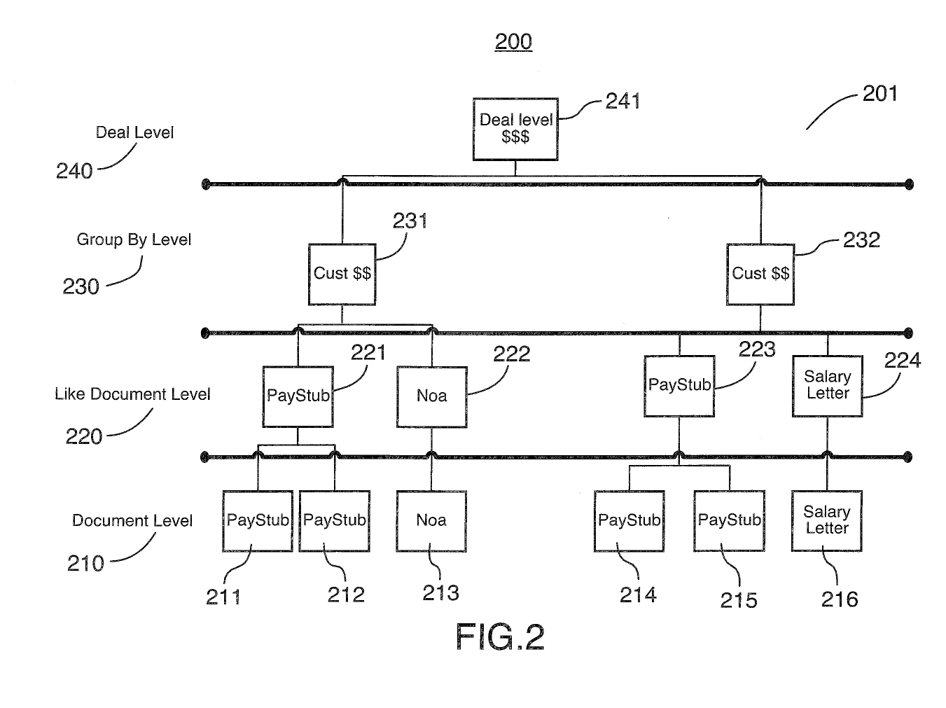

FIG. 2 is a chart illustrating a structure 200 for aggregating mortgage application related information 201 in accordance with an embodiment of the invention. The mortgage application related information 201 is entered into and stored in the memory 330 of the data processing system 300 in accordance with the structure 200. The structure 200 includes a document level (or first level) 210, a like document level (or second level) 220, a group document level (or third level) 230, and a deal aggregation level (or fourth level) 240.

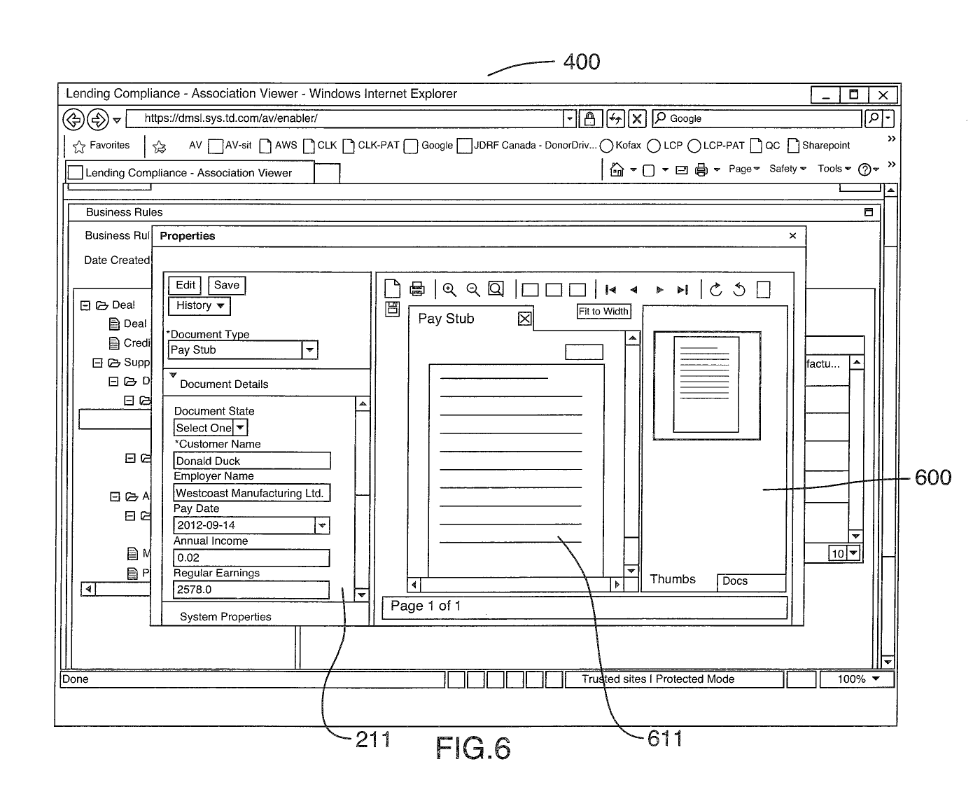

The document level 210 includes mortgage application related information 201 obtained from individual mortgage application related documents for each applicant or customer party to the mortgage application, transaction, or deal. For example, a first customer may provide a first pay stub, a second pay stub, and a notice of assessment (“NOA”) in support of a mortgage application. Similarly, a second customer may provide a first pay stub, a second pay stub, and a salary letter in support of the mortgage application. The first and second customers may be husband and wife, for example. For the first customer, first pay stub (or mortgage document) information 211, second pay stub (or mortgage document) information 212, and NOA information 213 may be stored in the memory 330 of the data processing system 300. Similarly, for the second customer, first pay stub information 214, second pay stub information 215, and a salary letter information 216 may be stored in the memory 330 of the data processing system 300. The first pay stub information 211, for example, may include the customer name, employer name, pay date, pay amount, annual income, regular earnings, and a scanned image of the pay stub (as shown in FIG. 6 and described in more detail below). The first pay stub information 211 may be entered into the system 300, for example, by electronic scanning of the first pay stub and character recognition, by manual entry by a user, or by a combination of electronic scanning and manual entry.

The like document level 220 includes mortgage application related information 201 obtained by aggregating information from like mortgage application related documents from the document level 210 for each customer party to the mortgage deal. For example, for the first customer, the first pay stub information 211 and the second pay stub information 212 from the document level 210 may be aggregated and stored as aggregate pay stub information 221 at the like document level 220. Similarly, for the first customer, the NOA information 213 from the document level 210 may be aggregated and stored as aggregate NOA information 222 at the like document level 220. Similarly, for the second customer, the first pay stub information 214 and the second pay stub information 215 from the document level 210 may be aggregated and stored as aggregate pay stub information 223 at the like document level 220. Similarly, for the second customer, the salary letter information 216 from the document level 210 may be aggregated and stored as aggregate salary letter information 224 at the like document level 220.

The group document level 230 includes mortgage application related information 201 obtained by aggregating information from the like document level 220 for each customer party to the mortgage deal. For example, for the first customer, the aggregate pay stub information 221 and the aggregate NOA information 222 may be aggregated and stored as first customer information 231 at the group document level 230. Similarly, for the second customer, the aggregate pay stub information 223 and the aggregate salary letter information 224 may be aggregated and stored as second customer information 232 at the group document level 230.

The deal aggregation level 240 includes mortgage application related information 201 obtained by aggregating information from the group document level 230 for each customer party to the mortgage deal. For example, the first customer information 231 and the second customer information 232 may be aggregated and stored as deal level information 241 at the deal aggregation level 240.

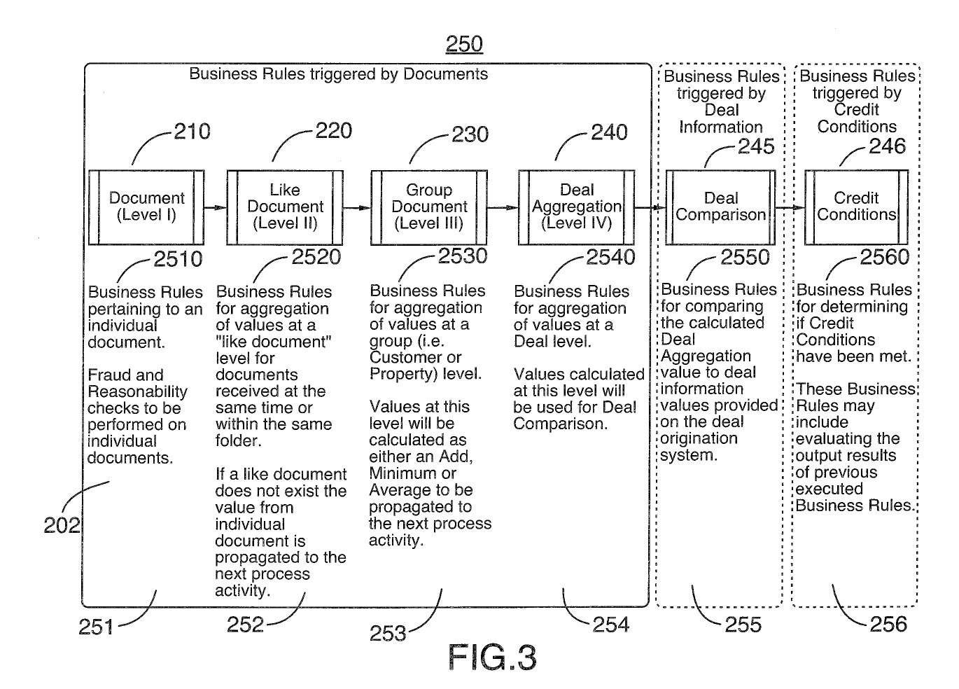

FIG. 3 is a flow chart illustrating the application 250 of business rules 202 for aggregating mortgage application related information 201 according to the structure 200 of FIG. 2 in accordance with an embodiment of the invention.

At step 251, business rules 2510 pertaining to individual mortgage application related documents are applied. For example, business rules relating to fraud detection and reasonability checks may be performed on mortgage application related information 201 from individual mortgage application related documents (e.g., first pay stub information 211) at the document level 210.

The rules 2510 applied at the document level 210 may be divided into different types of rules. For example, rules 2510 relating to pay stub information 211 may include the following rule types and example rules: dependency rules (e.g., “Validate if second piece of income verification is required”, etc.); reasonability rules (e.g., “Compare YTD earnings with annual income calculation”, “Validate employment agency”, “Missing or illegible fields”, “Validate employment type”, etc.); fraud rules (e.g., “Validate paystub is dated within 60 days of submission date”, “Compare regular earnings and hourly income calculations”, etc.); and, information rules (e.g., “Calculated annual income”, “CPP present”, “EI present”, “Pay frequency”, etc.). The application of each of these rules to pay stub information 211 may yield a numeric, alphanumeric, or logical result value.

As another example, rules 2510 relating to salary letter information 216 may include the following rule types and example rules: information rules (e.g., “Employment commenced”, “Calculated annual income”, “Pay frequency”, “Validate signature”, “Customer name”, “Employment status”, etc.); reasonability rules (e.g., “Validate employment agency”, “Missing or illegible fields”, “Employment status”, “Position of job title”, “Employer representative name”, etc.); and, fraud rules (“Employer name appears on TDCT fraudulent employers list”, “Extra due diligence: numbered company”, “Validate salary letter is dated within 60 days of submission date”, etc.). The application of each of these rules to salary letter information 216 may yield a numeric, alphanumeric, or logical result value.

As a further example, rules 2510 relating to NOA information 213 may include the following rule types and example rules: reasonability rules (e.g., “Balance missing from assessment”, “Missing or illegible fields”, etc.); information rules (e.g., “Previous account balance”, “Commissioner name”, “Line 150”, “18% of Donald Duck's income”, “Balance due”, “Final balance”, etc.); and, fraud rules (e.g., “Commissioner appropriate for tax year”, “Comparison between 18% of Donald Duck's earned income and line 150”, etc.). The application of each of these rules to NOA information 213 may yield a numeric, alphanumeric, or logical result value.

At step 252, business rules 2520 for the aggregation of values at the like document level 220 for documents received at the same time or within the same folder are applied. For example, if a like document does not exist, the value from an individual document is propagated to the next process activity (e.g., step 253).

The rules 2520 applied at the like document level 220 may also be divided into different types of rules. For example, rules 2520 relating to pay stub information 221 may include the following rule types and example rules: reasonability rules (e.g., “Multiple employers for same customer, please review”, etc.); and, information rules (e.g., “Calculated annual income from paystubs”, etc.). The application of each of these rules to pay stub information 221 may yield a numeric, alphanumeric, or logical result value.

As another example, rules 2520 relating to salary letter information 224 may include the following rule types and example rules: reasonability rules (e.g., “Multiple employers for same customer, please review”, etc.); and, information rules (e.g., “Calculated annual income from multiple salary letters”, etc.). The application of each of these rules to salary letter information 224 may yield a numeric, alphanumeric, or logical result value.

As a further example, rules 2520 relating to NOA information 222 may include the following rule types and example rules: information rules (e.g., “Line 150 income from NOAs”, etc.). The application of each of these rules to NOA information 222 may yield a numeric, alphanumeric, or logical result value.

At step 253, business rules 2530 for the aggregation of values at the group document level 230 (e.g., customer or property) are applied. For example, values at this level may be calculated as either an add, minimum, or average to be propagated to the next process activity (e.g., step 254).

The rules 2530 applied at the group document level 230 may also be divided into different types of rules. For example, rules 2530 relating to a first customer (e.g., “Donald Duck”) 231 may include the following rule types and example rules: reasonability rules (e.g., “Calculated income from multiple income documents”, etc.); and, information rules (e.g., “Calculated income for customer”, etc.). The application of each of these rules to first customer information 231 may yield a numeric, alphanumeric, or logical result value.

As another example, rules 2530 relating to a second customer (e.g., “Annie Apple”) 232 may include the following rule types and example rules: reasonability rules (e.g., “Calculated income from multiple income documents”, etc.); and, information rules (e.g., “Calculated annual income customer”, etc.). The application of each of these rules to second customer information 232 may yield a numeric, alphanumeric, or logical result value.

At step 254, business rules 2540 for the aggregation of values at the deal aggregation level 240 are applied. For example, values calculated at this level may be used by an optional deal comparison function 245.

At step 255, an optional deal comparison function 245 may be implemented in which business rules 2550 for comparing calculated deal aggregation values to deal information values provided by a deal origination system may be applied.

At step 256, an optional credit conditions function 246 may be implemented in which business rules 2560 for determining whether credit conditions have been met may be applied. For example, these business rules 2560 may include evaluating the output results of previously applied business rules.

Note that the business rules 2510, 2520, 2530, 2540 applied in the above steps 251, 252, 253, 254 are triggered by mortgage application related information 201 obtained from mortgage application related documents (e.g., first pay stub information 211). In contrast, the business rules 2550 applied in step 255 are triggered by deal information (e.g., deal level information 241) and the business rules 2560 applied at step 256 are triggered by credit conditions.

According to one embodiment, a number of review screens are provided for presentation to a user on a display 340 of the data processing system 300. These screens allow the user to visually review mortgage application related information 201 and the results and values obtained by the application of business rules 2510, 2520, 2530, 2540 to that information 201. These screens are described in the following.

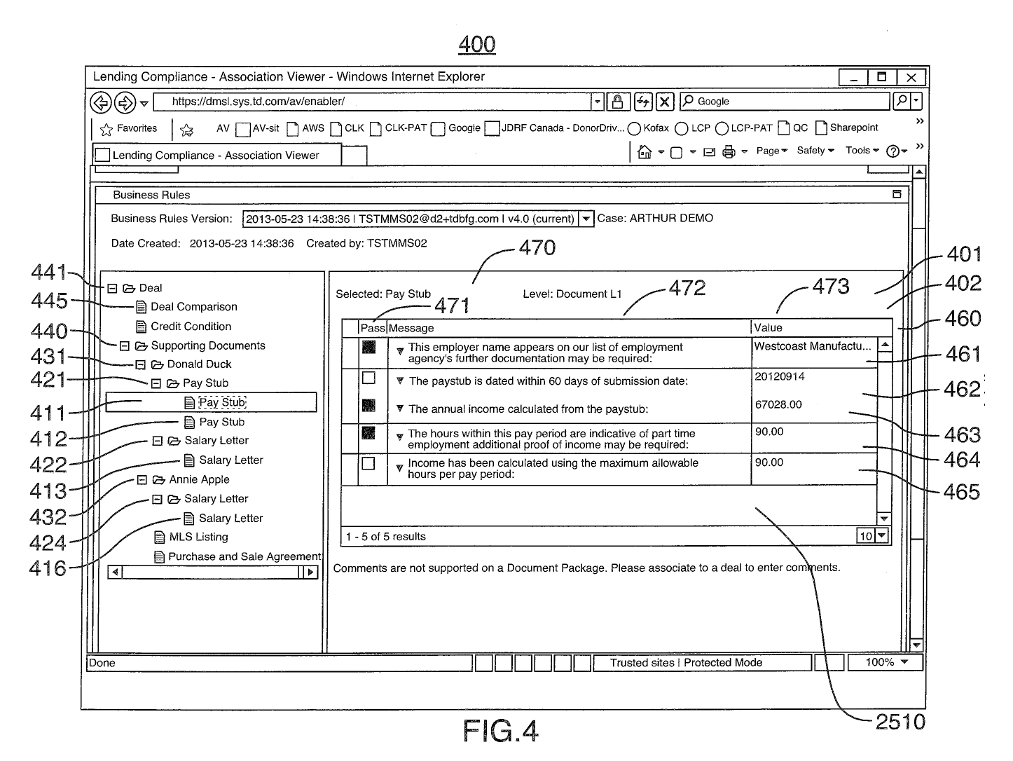

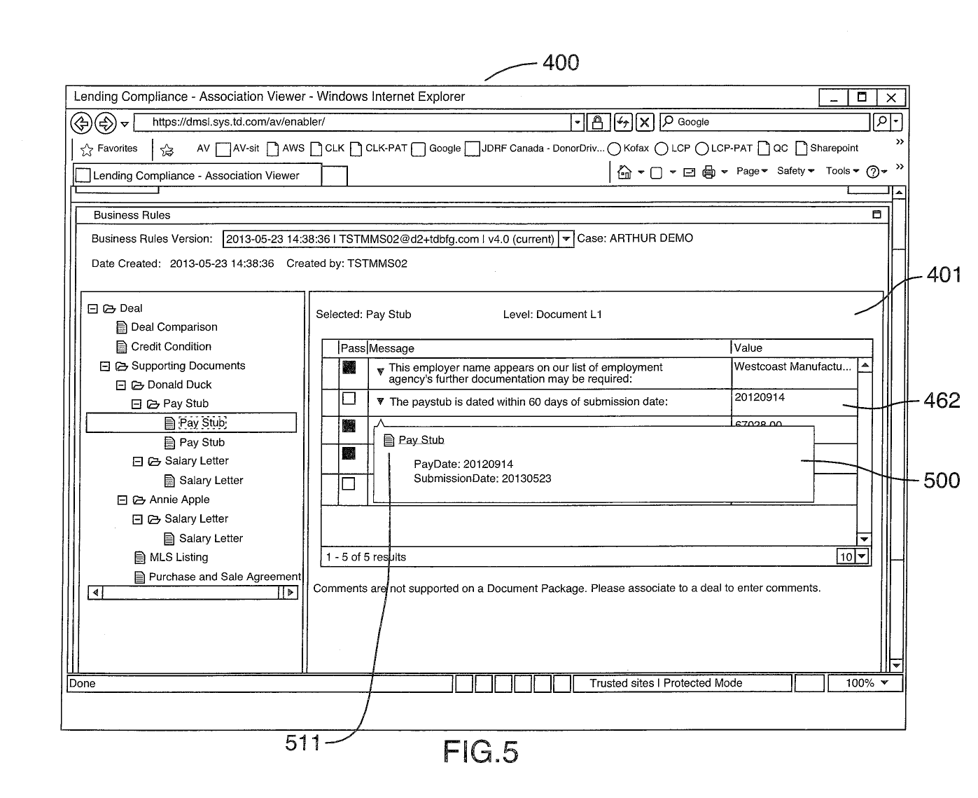

FIG. 4 is a screen capture illustrating a document level screen 400 for a mortgage application related document in accordance with an embodiment of the invention. FIG. 5 is a screen capture illustrating a pop-up window 500 for the mortgage application related document within the document level screen 400 of FIG. 4 in accordance with an embodiment of the invention. And, FIG. 6 is a screen capture illustrating a properties and document image screen 600 for the mortgage application related document of FIG. 4 in accordance with an embodiment of the invention.

According to one embodiment, as shown in FIG. 4, mortgage application related documents and mortgage application related information may be stored in a file structure or hierarchy within the memory 330 of the data processing system 300. For example, first and second pay stub information 211, 212 for a first customer (e.g., “Donald Duck”) may be stored in respective electronic files or documents 411, 412 within a pay sub folder 421 within a first customer folder 431. Similarly, NOA or salary letter information 213 for the first customer (e.g., “Donald Duck”) may be stored in a respective electronic file or document 413 in a NOA or salary letter folder 422 within the first customer folder 431. Similarly, salary letter information 216 for a second customer (e.g., “Annie Apple”) may be stored in a respective electronic file or document 416 in a salary letter folder 424 within a second customer folder 432. The first and second customer folders 431, 432 may be stored within a supporting documents folder 440 within a deal folder 441 for the deal. Additional supporting information and documents such as a NOA, a MLS™ listing, and a purchase and sale agreement may also be stored in the customer folders (e.g., 432) or supporting documents folder 440.

A first pay stub document 411 for the first customer (e.g., “Donald Duck”) is shown as being selected in FIG. 4. In response to this selection, a corresponding window 401 may be displayed in which the results of the application of business rules 2510 to the document 411 are presented. These results may be presented in the form of a table 402 having a number of fields 470 and a number of records 460. For example, each record (e.g., 461) may correspond to one of the business rules 2510 (which may be designated 461, 462, 463, 464, 465) and may include a pass field 471, a message field 472, and a value field 473. The pass field 471 may indicate whether the information 211 gathered from the document 411 meets the requirements of the business rule 461. The message field 472 may indicate the general nature or result of the business rule 461. And, the value field 273 may indicate a specific value or other information relating to the application of the business rule 461.

For example, a first business rule 461 may determine whether the employer name appearing in the pay stub document 411 is included in an approved list of employer names. A message to this effect may be presented in the message field 472 for the rule 461. (e.g., “This employer name appears on our list of employment agencies further documentation may be required . . . ”). If so, the pass field 471 for the rule 461 may be checked. In addition, the value field 473 for the rule 461 may list the employer's name (e.g., “Westcoast Manufacturing Ltd.”).

As another example, a second business rule 462 may determine whether the date appearing in the pay stub document 411 is within a predetermined date range (e.g., within 60 days of a submission date). A message to this effect may be presented in the message field 472 for the rule 462 (e.g., “This paystub is dated within 60 days of submission date . . . ”). If not, the pass field 471 for the rule 462 may be left unchecked. In addition, the value field 473 for the rule 462 may list the pay date (e.g., “20020914”).

To view additional result information for a rule (e.g., 462), the rule 462 may be selected as shown in FIG. 5. When selected, a pop-up window 500 may be presented in which the additional information (e.g., “Pay Date: 20100914”; “Submission Date: 20130523”) may be presented. In addition, an icon 511 representing the pay stub document 411 may be presented in the pop-up window 500.

To view further pay stub information 211 or properties obtained from the pay stub document 411, the icon 511 may be selected. When selected, a properties and document image screen 600 may be presented in which an image 611 of the pay stub document 411 may be viewed and further pay stub information 211 may be presented, edited, and saved. The pay sub information 211 may be stored as a database record having fields such as document type (e.g., “Pay Stub”), document state, customer name (e.g., “Donald Duck”), employer name (e.g., “Westcoast Manufacturing Ltd.”), pay date (e.g., “2012-09-14”), annual income (e.g., “0.02”), and regular earnings (e.g., “2578.0”).

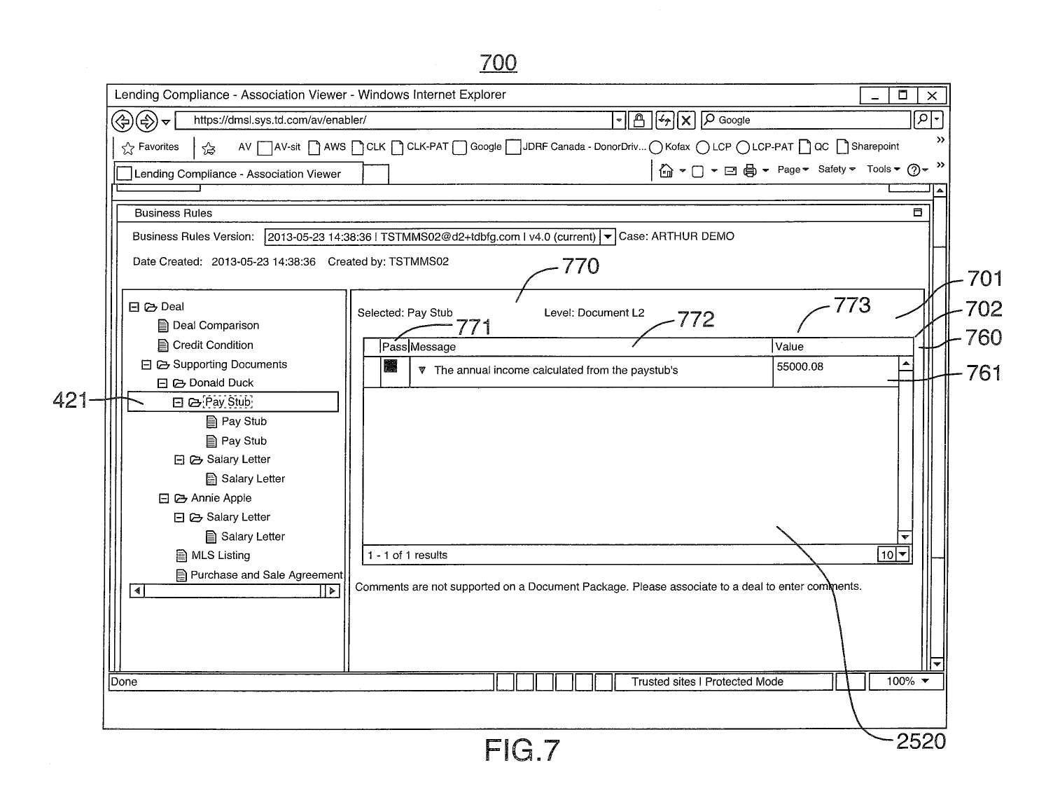

FIG. 7 is a screen capture illustrating a like document level screen 700 for like mortgage application related documents in accordance with an embodiment of the invention. The pay stub folder 421 for the first customer (e.g., “Donald Duck”) is shown as being selected in FIG. 7. In response to this selection, a corresponding window 701 may be displayed in which the results of the application of business rules 2520 to the like pay stub documents 411, 412 within the pay stub folder 421 are presented. These results may be presented in the form of a table 702 having a number of fields 770 and a number of records 760. For example, each record (e.g., 761) may correspond to one of the business rules 2520 (which may be designated 761) and may include a pass field 771, a message field 772, and a value field 773. The pass field 771 may indicate whether the information 211, 212 gathered from the documents 411, 412 meets the requirements of the business rule 761. The message field 772 may indicate the general nature or result of the business rule 761. And, the value field 773 may indicate a specific value or other information relating to the application of the business rule 761.

For example, a first business rule 761 may determine whether annual income calculated from the income information 211, 212 appearing in the pay stub documents 411, 412 is above a predetermined level (e.g., $45,000.00). A message to this effect may be presented in the message field 772 for the rule 761 (e.g., “The annual income calculated from the paystub is . . . ”). If so, the pass field 771 for the rule 761 may be checked. In addition, the value field 773 for the rule 761 may list the annual income (e.g., “55,000.00”).

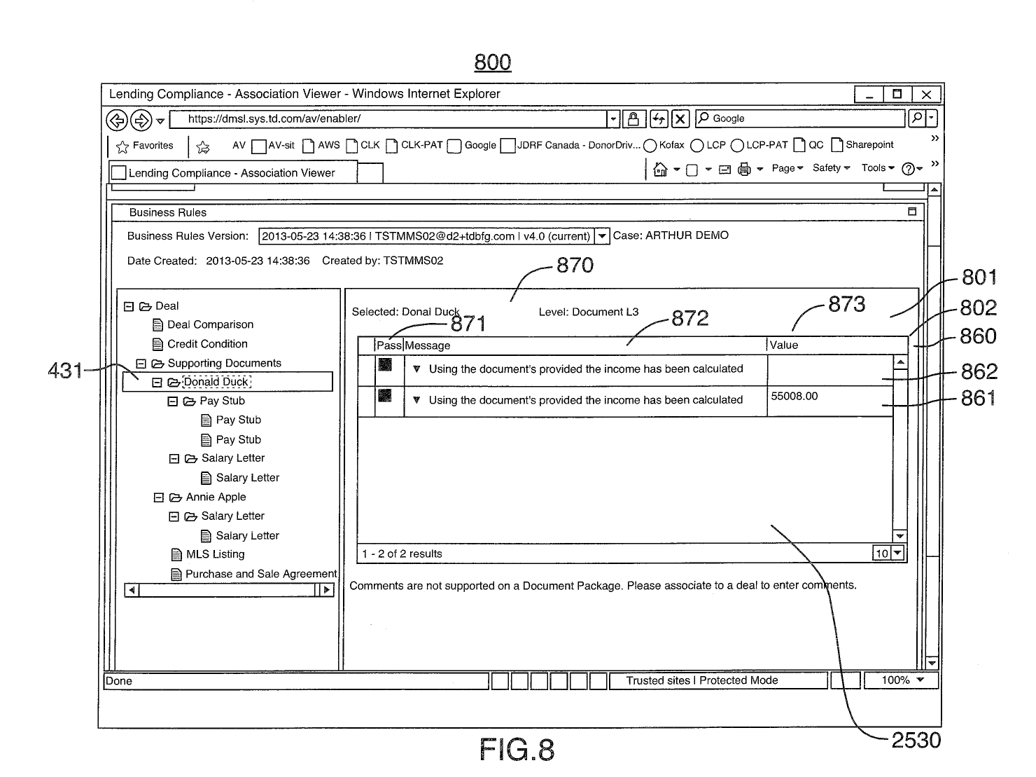

FIG. 8 is a screen capture illustrating a group document level screen 800 for a customer in accordance with an embodiment of the invention. The first customer folder 431 for the first customer (e.g., “Donald Duck”) is shown as being selected in FIG. 8. In response to this selection, a corresponding window 801 may be displayed in which the results of the application of business rules 2530 to the mortgage application related documents (e.g., pay stub documents 411, 412, NOA or salary letter documents 413, etc.) within the first customer folder 431 are presented. These results may be presented in the form of a table 802 having a number of fields 870 and a number of records 860. For example, each record (e.g., 861) may correspond to one of the business rules 2530 (which may be designated 861, 862) and may include a pass field 871, a message field 872, and a value field 873. The pass field 871 may indicate whether the information (e.g., 211, 212, 213) gathered from the documents (e.g., 411, 412, 413) within the first customer folder 431 meets the requirements of the business rule 861. The message field 872 may indicate the general nature or result of the business rule 861. And, the value filed 873 may indicate a specific value or other information relating to the application of the business rule 861.

For example, a first business rule 861 may determine whether income calculated from the income information appearing in the pay stub, NOA, or salary letter documents 411, 412, 413 is above a predetermined level (e.g., $45,000.00). A message to this effect may be presented in the message field 872 for the rule 861 (e.g., “Using the documents provided the income has been calculated . . . ”). If so, the pass field 871 for the rule 861 may be checked. In addition, the value field 873 for the rule 861 may list the income (e.g., “55,000.00”).

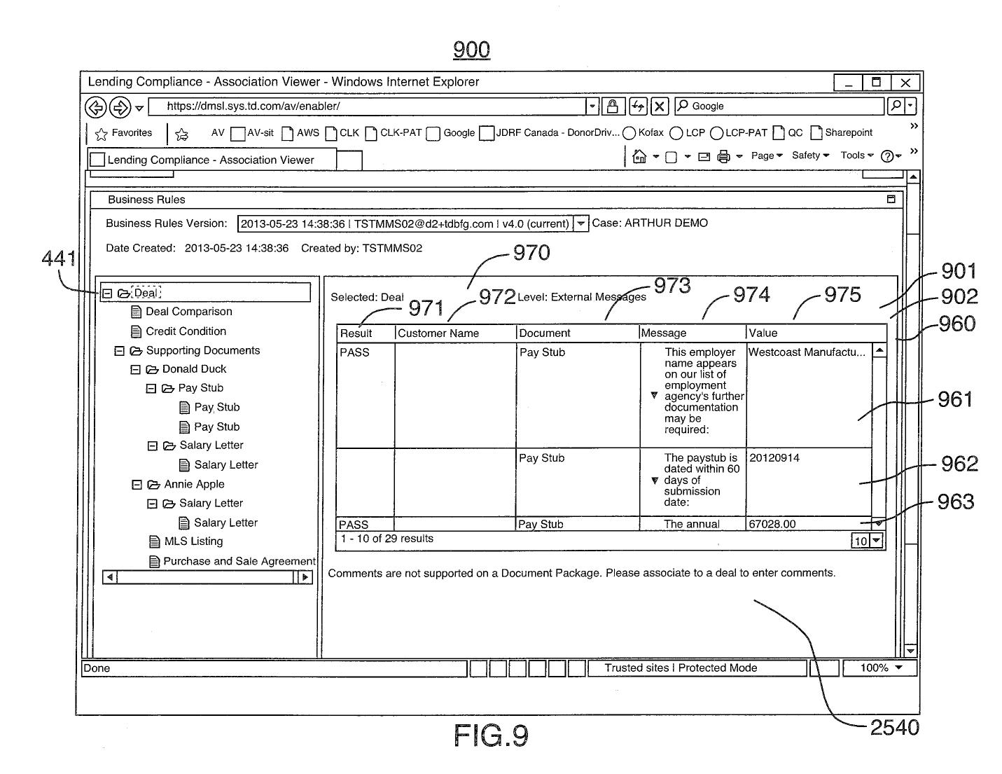

FIG. 9 is a screen capture illustrating a deal level screen 900 for one or more customers in accordance with an embodiment of the invention. The deal folder 441 is shown as being selected in FIG. 9. In response to this selection, a corresponding window 901 may be displayed in which the results of the application of business rules 2540 to the mortgage application related documents (e.g., pay stub documents 411, 412, NOA or salary letter documents 413, 416, MLS™ listings, purchase and sale agreements, etc.) within the first and second customer folders 431, 432 are presented. These results may be presented in the form of a table 902 having a number of fields 970 and a number of records 960. For example, each record (e.g., 961) may correspond to one of the business rules 2540 (which may be designated 961, 962, 963) and may include a result field 971, a customer name field 972, a document field 973, a message field 974, and a value field 975. The result field 871 may indicate (e.g., “PASS”) whether the information (e.g., 211, 212, 213, 216) gathered from the documents (e.g., 411, 412, 413, 416) within the first and second customer folders 431, 432 meets the requirements of the business rule 961. The customer name field 972 may indicate the name of the customer (e.g., “Donald Duck”, “Annie Apple”). The document field 973 may indicate the type of document (e.g., “Pay Stub”). The message field 974 may indicate the general nature or result of the business rule 961. And, the value field 975 may indicate a specific value or other information relating to the application of the business rule 961.

For example, a first business rule 961 may determine whether the employer name appearing on the pay stub documents 411, 412 is included in an approved list of employer names. A message to this effect is presented in the message field 974 for the rule 961 (e.g., “This employer name appears on our list of employment agencies further documentation may be required . . . ”). If so, the result field 971 for the rule 961 may be marked “PASS”. In addition, the value field 975 for the rule 961 may list the employer's name (e.g., “Westcoast Manufacturing Ltd.”).

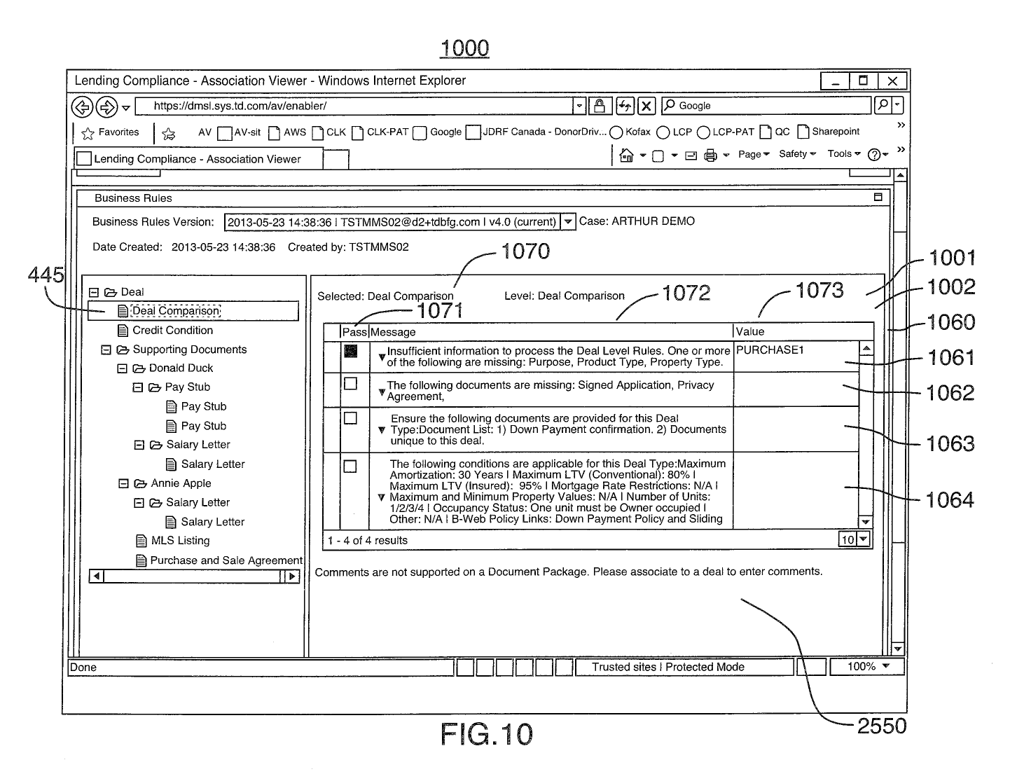

FIG. 10 is a screen capture illustrating a deal comparison screen 1000 in accordance with an embodiment of the invention. A deal comparison document 445 for the deal is shown as being selected in FIG. 10. In response to this selection, a corresponding window 1001 may be displayed in which the results of the application of business rules 2550 to the deal level information 241 are presented. These results may be presented in the form of a table 1002 having a number of fields 1070 and a number of records 1060. For example, each record (e.g., 1061) may correspond to one of the business rules 2550 (which may be designated 1061, 1062, 1063, 1064) and may include a pass field 1071, a message field 1072, and a value field 1073. The pass field 1071 may indicate whether the deal level information (e.g., 241) gathered from the various documents (e.g., 411, 412, 413, 416) meets the requirements of the business rule 1061. The message field 1072 may indicate the general nature or result of the business rule 1061. And, the value filed 1073 may indicate a specific value or other information relating to the application of the business rule 1061.

For example, a first business rule 1061 may determine whether sufficient information has been provided to process the deal. A message to this effect is presented in the message field 1072 for the rule 1061 (e.g., “Insufficient information to process the Deal Level Rules. One or more of the following are missing: Purpose, Product Type, Property Type . . . ”). If so, pass field 1071 for the rule 1061 may be checked. In addition, the value field 1073 for the rule 1061 may list the purpose of the deal (e.g., “PURCHASE1”).

As mentioned above, the present invention is applicable not only to mortgage applications as described above but also to transactions and applications in general including business transactions, financial transactions, mortgage transactions, loan transactions, and applications for mortgages, financial products, letters of credit, credit cards, passports, drivers' licenses, etc.

Aspects of the above described method may be summarized with the aid of a flowchart.

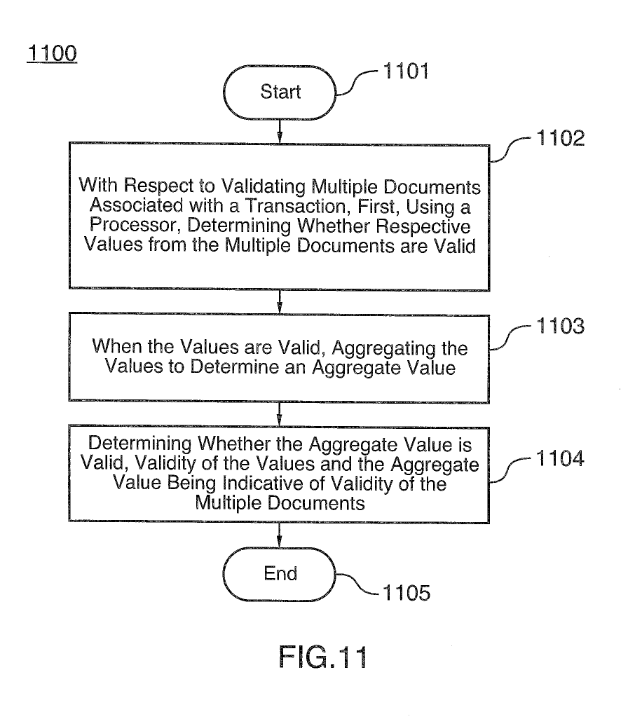

FIG. 11 is a flow chart illustrating operations 1100 of modules (e.g., 331) within a data processing system (e.g., 300) for validating multiple documents (e.g., 411, 412, 413) associated with a transaction, in accordance with an embodiment of the invention.

At step 1101, the operations 1100 start.

At step 1102, using a processor 320, a determination is made as to whether respective values (e.g., 473) from the multiple documents 411, 412, 413 are valid.

At step 1103, when the values 473 are valid, the values 473 are aggregated to determine an aggregate value (e.g., 873.

At step 1104, a determination is made as to whether the aggregate value 873 is valid), validity of the values 473 and the aggregate value 873 being indicative of validity of the multiple documents 411, 412, 413.

At step 1105, the operations 1100 end.

The above method may further include determining the respective values 473 from respective information 211, 212, 213 extracted from the multiple documents 411, 412, 413. The determining of the respective values 473 from the respective information 211, 212, 213 extracted from the multiple documents 411, 412, 413 and the determining whether the respective values 473 from the multiple documents 411, 412, 413 are valid may include applying a lowest level of rules (e.g., 461, 2510) to the information 211, 212, 213 and the values 473. The aggregating the values 473 to determine the aggregate value 873 may include applying one or more intermediate levels of rules (e.g., 761, 861, 2520, 2530) to the values 473 to aggregate values from ones of the multiple documents of a same type (e.g., 411, 412) before aggregating values from others of the multiple documents of a different type (e.g., 413). The determining whether the aggregate value 873 is valid may include applying a highest level of rules (e.g., 961, 2540) to the aggregate value 873. The respective values 473 from the multiple documents 411, 412, 413 are valid when within respective predetermined ranges of values and wherein the aggregate value 873 is valid when above a predetermined aggregate value (e.g., $45,000.00). The method may further include presenting on a display 340 at least one of the values 473, respective indications 471 as to whether the values 473 are valid, the aggregate value 873, and an indication 871, 971 as to whether the aggregate value 873 is valid. The aggregate value 873 may be a sum of the values 473. The transaction may be an application for the transaction. And, the transaction may be one of a business transaction, a financial transaction, a mortgage transaction, a loan transaction, and an application for one of a mortgage, a financial product, a letter of credit, a credit card, a passport, and a driver's license.

According to one embodiment, each of the above steps 1101-1105 may be implemented by a respective software module 331. According to another embodiment, each of the above steps 1101-1105 may be implemented by a respective hardware module 321. According to another embodiment, each of the above steps 1101-1105 may be implemented by a combination of software 331 and hardware modules 321. For example, FIG. 11 may represent a block diagram illustrating the interconnection of specific hardware modules 1101-1105 (collectively 321) within the data processing system 300, each hardware module 1101-1105 adapted or configured to implement a respective step of the method of the invention.

While this invention is primarily discussed as a method, a person of ordinary skill in the art will understand that the apparatus discussed above with reference to a data processing system 300 may be programmed to enable the practice of the method of the invention. Moreover, an article of manufacture for use with a data processing system 300, such as a pre-recorded storage device or other similar computer readable medium or computer program product including program instructions recorded thereon, may direct the data processing system 300 to facilitate the practice of the method of the invention. It is understood that such apparatus, products, and articles of manufacture also come within the scope of the invention.

In particular, the sequences of instructions which when executed cause the method described herein to be performed by the data processing system 300 may be contained in a data carrier product according to one embodiment of the invention. This data carrier product may be loaded into and run by the data processing system 300. In addition, the sequences of instructions which when executed cause the method described herein to be performed by the data processing system 300 may be contained in a computer software product or computer program product (e.g., comprising a non-transitory medium) according to one embodiment of the invention. This computer software product or computer program product may be loaded into and run by the data processing system 300. Moreover, the sequences of instructions which when executed cause the method described herein to be performed by the data processing system 300 may be contained in an integrated circuit product (e.g., a hardware module or modules 321) which may include a coprocessor or memory according to one embodiment of the invention. This integrated circuit product may be installed in the data processing system 300.

The embodiments of the invention described above are intended to be exemplary only. Those skilled in the art will understand that various modifications of detail may be made to these embodiments, all of which come within the scope of the invention.

What is claimed is:

1. A method for validating multiple documents associated with a transaction, comprising:
using a processor, determining whether respective values from the multiple documents are valid;
when the values are valid, aggregating the values to determine an aggregate value; and,
determining whether the aggregate value is valid, validity of the values and the aggregate value being indicative of validity of the multiple documents.

2. The method of claim 1 and further comprising determining the respective values from respective information extracted from the multiple documents.

3. The method of claim 2 wherein the determining of the respective values from the respective information extracted from the multiple documents and the determining whether the respective values from the multiple documents are valid includes applying a lowest level of rules to the information and the values.

4. The method of claim 3 wherein the aggregating the values to determine the aggregate value includes applying one or more intermediate levels of rules to the values to aggregate values from ones of the multiple documents of a same type before aggregating values from others of the multiple documents of a different type.

5. The method of claim 4 wherein the determining whether the aggregate value is valid includes applying a highest level of rules to the aggregate value.

6. The method of claim 1 wherein the respective values from the multiple documents are valid when within respective predetermined ranges of values and wherein the aggregate value is valid when above a predetermined aggregate value.

7. The method of claim 6 and further comprising presenting on a display at least one of the values, respective indications as to whether the values are valid, the aggregate value, and an indication as to whether the aggregate value is valid.

8. The method of claim 1 wherein the aggregate value is a sum of the values.

9. The method of claim 1 wherein the transaction is an application for the transaction.

10. The method of claim 1 wherein the transaction is one of a business transaction, a financial transaction, a mortgage transaction, a loan transaction, and an application for one of a mortgage, a financial product, a letter of credit, a credit card, a passport, and a driver's license.

11. A system for validating multiple documents associated with a transaction, comprising:
a processor coupled to memory and a display; and,
at least one of hardware and software modules within the memory and controlled or executed by the processor, the modules including:
a module for determining whether respective values from the multiple documents are valid;
a module for, when the values are valid, aggregating the values to determine an aggregate value; and,
a module for determining whether the aggregate value is valid, validity of the values and the aggregate value being indicative of validity of the multiple documents.

12. The system of claim 11 and further comprising a module for determining the respective values from respective information extracted from the multiple documents.

13. The system of claim 12 wherein the module for determining of the respective values from the respective information extracted from the multiple documents and the module for determining whether the respective values from the multiple documents are valid includes a respective module for applying a lowest level of rules to the information and the values.

14. The system of claim 13 wherein the module for aggregating the values to determine the aggregate value includes a module for applying one or more intermediate levels of rules to the values to aggregate values from ones of the multiple documents of a same type before aggregating values from others of the multiple documents of a different type.

15. The system of claim 14 wherein the module for determining whether the aggregate value is valid includes a module for applying a highest level of rules to the aggregate value.

16. The system of claim 11 wherein the respective values from the multiple documents are valid when within respective predetermined ranges of values and wherein the aggregate value is valid when above a predetermined aggregate value.

17. The system of claim 16 and further comprising a module for presenting on the display at least one of the values, respective indications as to whether the values are valid, the aggregate value, and an indication as to whether the aggregate value is valid.

18. The system of claim 11 wherein the aggregate value is a sum of the values.

19. The system of claim 11 wherein the transaction is an application for the transaction.

20. The system of claim 11 wherein the transaction is one of a business transaction, a financial transaction, a mortgage transaction, a loan transaction, and an application for one of a mortgage, a financial product, a letter of credit, a credit card, a passport, and a driver's license.
